(19) United States
(12) Patent Application Publication
(10) Pub. No.: US 2012/0168493 A1
(43) Pub. Date: Jul. 5, 2012

(54) Matrix Barcode System

(76) Inventor: Amichai Worms, Halfa (IL)

(21) Appl. No.: 12/983,923

(22) Filed: Jan. 4, 2011

(51) Int. Cl. G06F 17/00

(52) U.S. Cl. 235/375

(57) ABSTRACT

A method for user interaction with network servers by means of matrix codes includes: generating a matrix code associated with an object; scanning said matrix code by means of software adapted for such purpose; and interacting with digital objects associated with the matrix code by means of software adapted for such purpose. The user may interact with the networked servers via the matrix codes.

### BACKGROUND

1. Technical Field

Embodiments of the present invention relate generally to two-dimensional matrix ‘bar codes’ by which people, objects, events, articles and the like may be identified and interacted with in a Social Network.

2. Description of Related Art

Matrix codes such as Toyota's QR (quick-response) code, the Data Matrix, Shotcode, mCode and others (see FIG. 1) serve as unique identifiers, in the fashion of bar codes, for a variety of purposes. For example a product may be labeled with a matrix code enabling a customer bearing a smartphone to read the code using the phone, and thereby to retrieve networked information concerning the product and/or related information. Matrix codes storing addresses and URLs may appear in magazines, on signs, buses, business cards, or other objects about which users might need information. Users possessing a camera phone equipped with the correct software can scan the image of the code in order to display text, contact information, connect to a wireless network, open a web page in a phone's browser, or perform a variety of other tasks depending on the data embedded in the matrix code. This act of linking from physical world objects bearing such codes is known as a hardlink, or ‘physical world hyperlink’. Matrix codes can be used to display text to the user, to add a vCard contact to the user's device, to open a URI, or to compose a text message or email. Users can also generate and print their own QR Code for others to scan and use by visiting one of several free QR Code generating sites.

However these codes have to date been used only for object identification and/or hardlinking.

Hence, an improved method for broadened use of matrix codes is still a long felt need.

### BRIEF SUMMARY

According to an aspect of the present invention, there is provided a system and method for use of matrix bar codes to represent objects both in the physical world and in social networks. Examples of use in a social network include providing matrix codes associated with digital objects such as videos, fan page, events, status messages, posts, messages, applications, groups, and the like. In particular, the invention facilitates a direct connection between the real world and social networks; a matrix code captured by (for instance) a smartphone camera, allows automation of the process of locating a digital object such as a webpage, and interaction with said digital object, such as responding to an invitation.

It is within provision of the invention to provide a method for user interaction with network servers by means of matrix codes comprising steps of:
a. Using the social network or a third party application to generate a matrix code associated with an object in the social network;
b. scanning said matrix code by means of hardware and software adapted for such purpose;
c. interacting with digital objects associated with said matrix code by means of software adapted for such purpose;
whereby said user may interact with said networked servers by means of said matrix codes.

It is further within provision of the invention to provide the aforementioned method wherein said external object is selected from the group consisting of: a person, a place, an event, an article, a billboard, an advertisement, an invitation.

It is further within provision of the invention to provide the aforementioned method wherein said matrix code is selected from the group consisting of: a two-dimensional bar code, a one-dimensional bar code, a three-dimensional bar code, a holographic bar code, an audio bar code, a video bar code.

It is further within provision of the invention to provide the aforementioned method wherein said software runs on a cell phone.

It is further within provision of the invention to provide the aforementioned method wherein said interaction takes a form selected from the group consisting of: pressing a button, entering information, speaking, writing, gesturing, interacting with a touchscreen by pressing, dragging, drawing, and tapping with one or more fingers or stylus.

It is further within provision of the invention to provide the aforementioned method wherein said button is selected from the group consisting of: a ‘like’ button, an attendance button, a non-attendance button, a ‘maybe’ button, a ‘cancel event’ button, a ‘post to wall’ button, a comment button, a message button, and a ‘poke’ button.

It is further within provision of the invention to provide the aforementioned method wherein said matrix code is used to identify an entity selected from the group consisting of: person, place, thing, business, organization, event, group, institution, product.

It is further within provision of the invention to provide the aforementioned method wherein said matrix code is used to interact with an entity selected from the group consisting of: person, place, thing, business, organization, event, group, institution, product.

It is within provision of the invention that the application facilitating interaction between user and network allow for various types of response, depending upon a number of factors including type of object that is barcoded, identity of user, and relation between object barcoded and user.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates various matrix code schemes;

FIG. 2 illustrates an event identified by matrix code;

FIG. 3 illustrates a person's online personality identified by matrix code;

FIG. 4 illustrates an online business presence identified by matrix code;

FIG. 5 illustrates a newspaper article associated with ‘like’ and ‘comment’ matrix codes;

FIG. 6 illustrates an invitation tagged with a matrix code;

FIG. 7 illustrates a billboard tagged with a matrix code;

FIG. 8 illustrates a flyer tagged with a matrix code; and,

FIG. 9 illustrates a social network with an interaction provision.

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a system for use of matrix barcodes.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer (e.g, 1, 5, or 10).

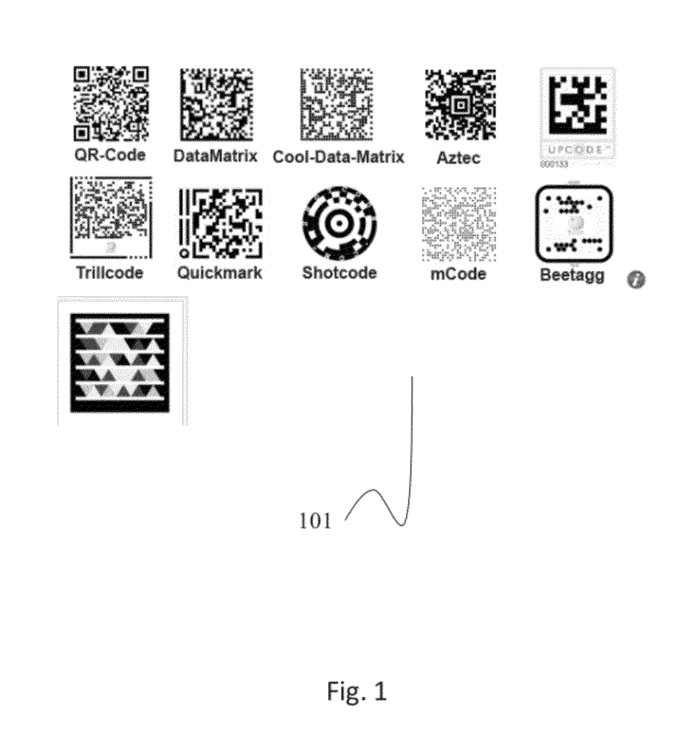

The term ‘matrix barcode’ refers hereinafter to an optical machine-readable representation of data in one, two, or more dimensions. This may comprise a printed, projected, illuminated or otherwise visible marker(s) bearing information in its geometric form that is readable or scannable by suitable instruments. For example a simple linear barcode or UPC code such as is commonly used to mark merchandise, being read for instance by laser scanners at supermarket checkouts, is a one-dimensional example of such a code. The two dimensional versions shown in FIG. 1 are also examples of such codes. The codes may be embedded with images, video, audio or other signals and may bear a variety of data such as binary data, trinary data, or the like which may be used to encode text, hyperlinks, image data, audio data (as in the case of the audio track on movie reels) or other information.

The use of barcodes is widespread in many industries to identify objects such as merchandise, train cars, pallets, and other objects that tend to move or be moved through their useful life. The codes allow automatic tracking of these objects, as the codes may be read by automated scanners. The scanners are generally connected to computing means that allow tracking of the items, facilitating inventory control and other functions.

In recent times these codes have been updated, taking two dimensional forms. The readers have likewise advanced, for example taking the form of optical recognition software running on a smart phone equipped with a camera. Such a phone can take a picture containing an appropriate barcode, and extract the information contained in said code which can generally speaking be represented as a binary sequence. This sequence may encode a variety of information, such as text, a hyperlink, an identification number, audio data and the like. The information so encoded may then allow the recognition software to download or otherwise access related information such as current auction prices for the item, its rating in a product rating system, technical parameters, or the like.

It is consistent with embodiments of the invention that the functionality of these codes be extended to allow a user of a reading device to interact with social networks by means using the encoded data. For example a social network such as Facebook, Twitter, or LinkedIn may generate such codes to represent objects in the social network (such as video, fan page, person, event, status, posts, messages, applications, groups, etc). Alternatively, third parties may generate such codes to represent objects in the social network or other objects.

The matrix barcode may either be in a proprietary format that can be easily identified with the naked eye or have a trademark or other IP protection symbol such as the logo of the social network or a special sign or mark, or both.

We now give some examples of different uses consistent with the invention.

In a first example, a person generates a matrix barcode by use of a website adapted for this purpose. The person then may use it in a physically tangible form (i.e. after printing) wherever it is suitable, for example:
a. A person may use the code on a Business Card or name tag, codes may be put adjacent to participants attending an event, etc.
b. Codes may be used on websites such as a Business fan page, a digital business card, on Advertisements (be they online, printed, or on TV or other media), brochures, etc.
c. Events may be associated with matrix codes, which may be printed for instance on invitations, advertisements and the like.
d. Blog posts may employ matrix codes in digital form, and they likewise may be employed in paper copies of a newspaper or publication.
e. A group such as political parties, social movements, unions, student or workers groups, student fraternities, may use such codes to identify the group or individuals within the group.

A second example details a ‘Call to Action’. In this case the 2d barcode serves as a call to action in the sense that it facilitates a response from the user. For example, the matrix code may implement the functionality of a physical ‘like’ button as seen on Facebook. This functionality may be implemented in software running (for instance) on the social network's official smartphone application, or on a third party application that interacts with the social networks using it's APIs; when the image is scanned, a ‘like’ button will appear onscreen, allowing the user to either implement the pressing of a ‘like’ button concerning the object bearing the barcode, or not. This functionality may extend to operation other than use of a ‘like’ button, for instance allowing users to indicate attendance (an ‘attend’ button), to send a message by use of an appropriate button, to add a friend, or the like, depending on the type of object involved.

The matrix barcode, in certain implementations consistent with the invention, may be read using a smartphone application associated with a particular social network. The smartphone application will verify that the matrix barcode has the social network's unique format or identifying marks, and will subsequently decode the encoded string and retrieve from the social network's server the relevant digital object (which for instance may be a webpage specifying an event, person, fan page, post, etc).

The social network's smartphone application may then verify the relationship between the currently logged in user and the retrieved object and offer to act accordingly. It is within provision of the invention that the application may act in a variable manner depending on the entity involved (such as event, person, business) involved and the relationship between the user and the entity involved (such as attending or not, is friend or not, likes or not, etc).

It is within provision of the invention that the application facilitating interaction between user and network allow for various types of response, depending upon a number of factors including type of object that is barcoded, identity of user, and relation between object barcoded and user.

It is within provision of the invention that the method of interaction described above be implemented on any device having scanning capability and having electronic communication with processing means, such as a PDA, smartphone, laptop computer, tablet computer,

### CMS Integration

CMS, or “Content Management System” refers to software systems used by people that manage online content, from simple blogs to big media corporations such as newspapers etc. Currently many newspapers come in three forms: physical paper, a web version, and a fan page.

In one implementation consistent with the invention the CMS may integrate with a social network through an API (application programming interface), such that the printed version of a newspaper, magazine, or the like includes 2d barcodes for the purpose(s) of soliciting comments, ‘like’ responses, or similar interaction, for each article, picture, cartoon, etc. It is within provision of the invention that the CMS will generate such buttons in the printed version for every article and photo or apply an editorial policy, for example generating such buttons only on the editorial page, or only on opinion notes, or not on articles involving serious crime, or similar.

We now consider an example of such use of the system. An event is being promoted, that a given user may attend. A piece of printed matter such as an invitation or newspaper ad is prepared that contains a matrix code associated with the event. Upon scanning the matrix barcode with a smartphone (for example), the smartphone application will then display a digital object associated with the barcode such as the event's venue and time information, as well as facilitate interaction by means of RSVP buttons for attendance possibilities such as ‘Yes’, ‘no’, and ‘maybe’.

A further example is now given concerning an event the user cannot attend. The smartphone application in this case will show the event's venue and time info and a button to send a message to the event owner.

A further example is now given concerning an event the user is attending. The smartphone application will show the event's info and a button to NOT attend the event or to post a message to a website associated with the event (such as its ‘wall’ on facebook).

A further example is now given concerning an event the user is organizing. Upon scanning a matrix code associated with the event, the smartphone application will show the event's venue and time info, and a button to allow the organizer to cancel the event.

A further example is now given concerning a person the user is a ‘friend’ of, in the sense of being linked on a social website. Upon scanning a matrix code associated with this person, the smartphone application will show the person's personal info, such as profile picture and the like, as well as buttons to send a message, poke, write to wall, etc.

A further example is now given concerning a person the user is not a ‘friend’ of, in the sense of not being linked on a social website. The smartphone application will show the person's info, the profile picture and buttons to add this person as friend, send a message, poke, etc.

A further example is now given concerning a fan page the user has ‘not liked’. The smartphone application will show the person's info, the profile picture and buttons to like.

A further example is now given concerning an internet fan page the user has liked. The smartphone application will show the person's info, the profile picture and buttons to write in the fan page wall, etc.

A set of examples will now be given, referring to the figures.

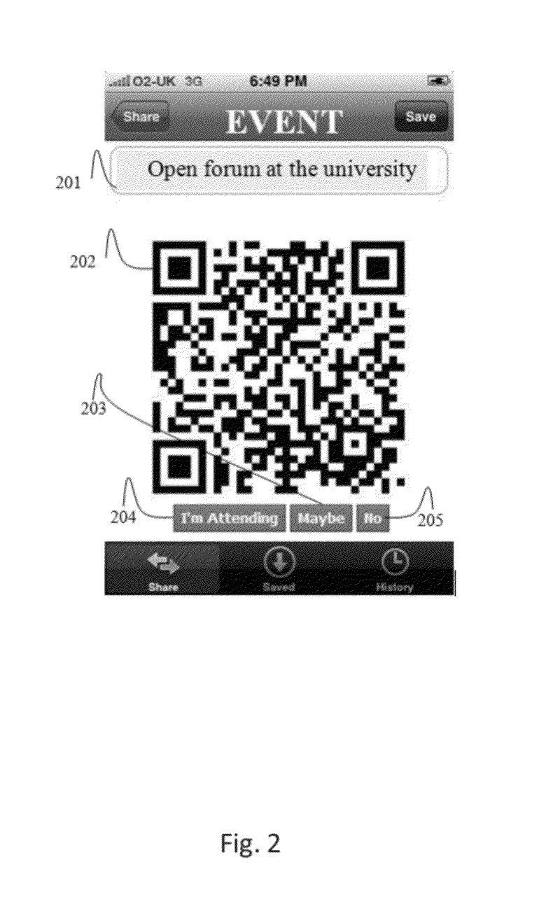

In FIG. 2 we see an example of a screen from a smartphone application implementing certain provisions of the invention. The matrix code 202 has been scanned, for instance from a newspaper advertisement for an open forum at the university. The code is scanned and reproduced on the smartphone screen, along with an event description 201, as well as response buttons 203,204,205. These buttons (for indicating intended attendance, possible attendance, and non-attendance, respectively) are linked for example to a site gathering such feedback from all responders, such that an estimate of attendance may be generated, and/or such that auxiliary information may be sent to attendees, and/or such that tickets maybe issued, and/or such that fees may be requested of attendants, and the like.

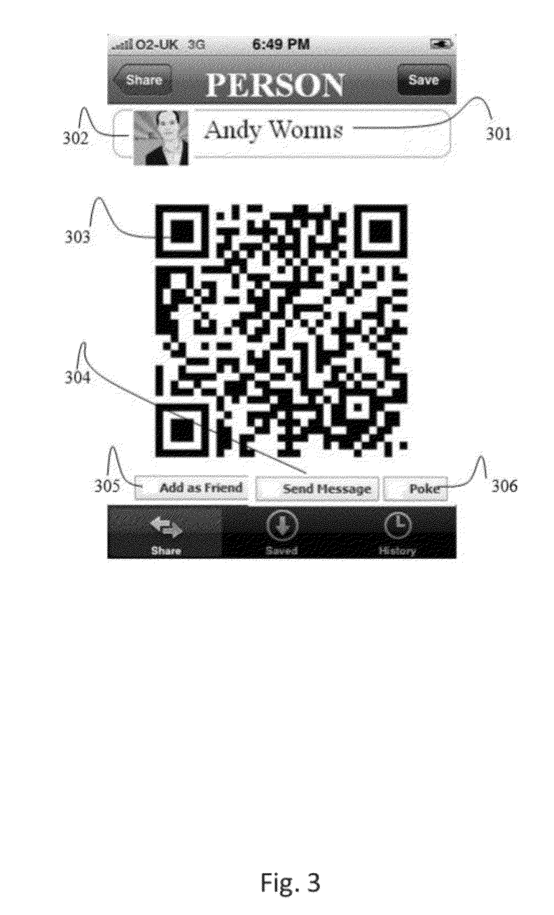

In FIG. 3 a further example is given wherein a person's personal matrix code has been scanned in, for example from a nametag or business card. The person's name 301, picture 302 both appear on the application screen which also displays the matrix code 303 that has also been scanned. Further buttons 305,304, 306 are provided to allow the user to add the scanned personality 301,302 as a friend (e.g. in Facebook), to send a message, or to poke (in the sense common on online communities and social networks, for instance), respectively.

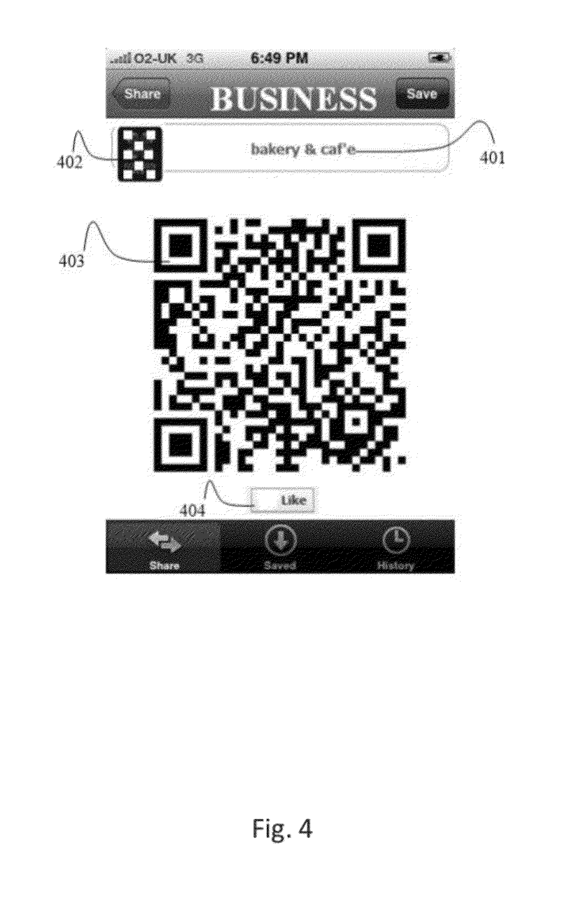

In FIG. 4 a further example is given wherein a business matrix code is used. The business name 401 and logo 402 appear upon scanning of the businesses matrix code 403, which may appear for instance on the menu, signage, or the like. The user of the software application may then interact digitally, for example by clicking a ‘like’ button for this business by pressing the appropriate button 404. As will be clear to one skilled in the art, other buttons and means for interaction may be provided, such as buy or sell offers, ads, messages, quizzes, polls, and any other means of digital interaction as may be found desirable.

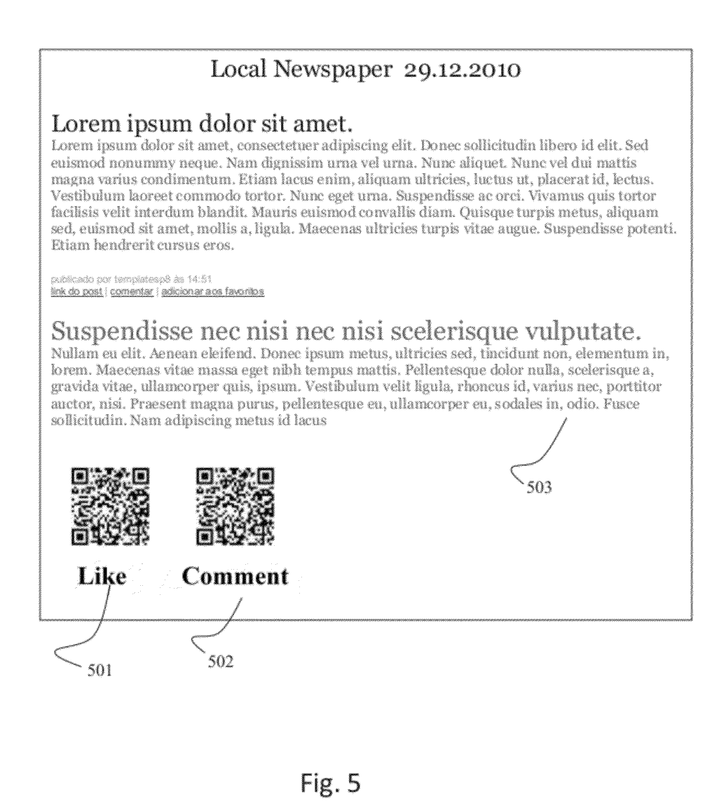

In FIG. 5 a further example is given wherein different matrix codes 501, 502 are used to directly indicate interaction information, in this case sending a ‘like’ or ‘comment’ request to a server upon scanning the appropriate matrix code. This example shows such codes being included in part of a printed newspaper article 503.

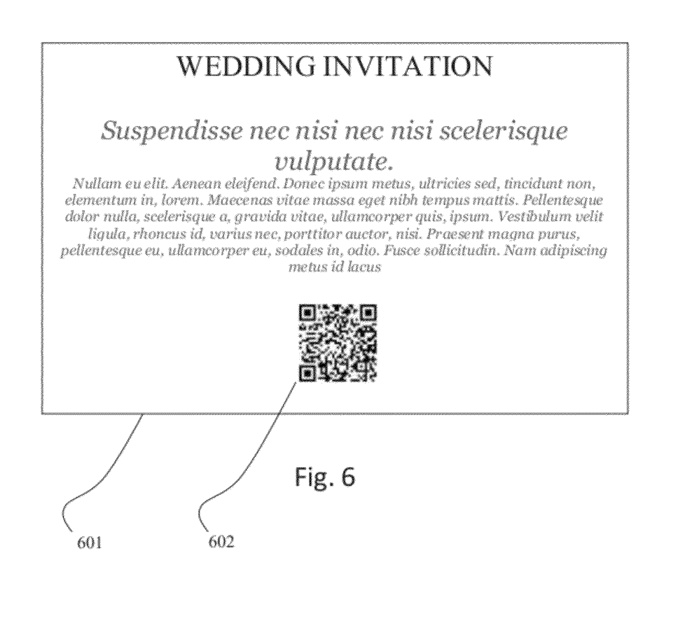

In FIG. 6 a further example is given wherein a wedding invitation 601 is printed with a matrix code 602 included. This matrix code may be used to indicate participation or nonparticipation, and/or may be linked to wedding information, a wedding registry, and the like.

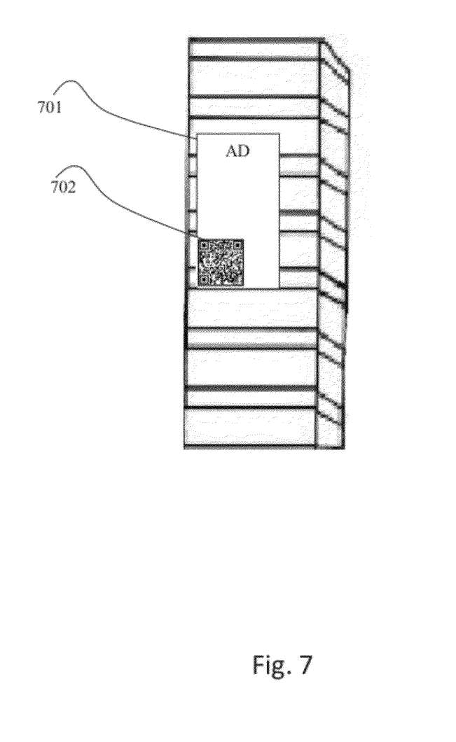

In FIG. 7 a further example is shown wherein a billboard 701 is printed having a matrix code included. This matrix code may be scanned by a smartphone running appropriate software, and used to interact with digital objects associated with the billboard such as a product website, review site, or the like.

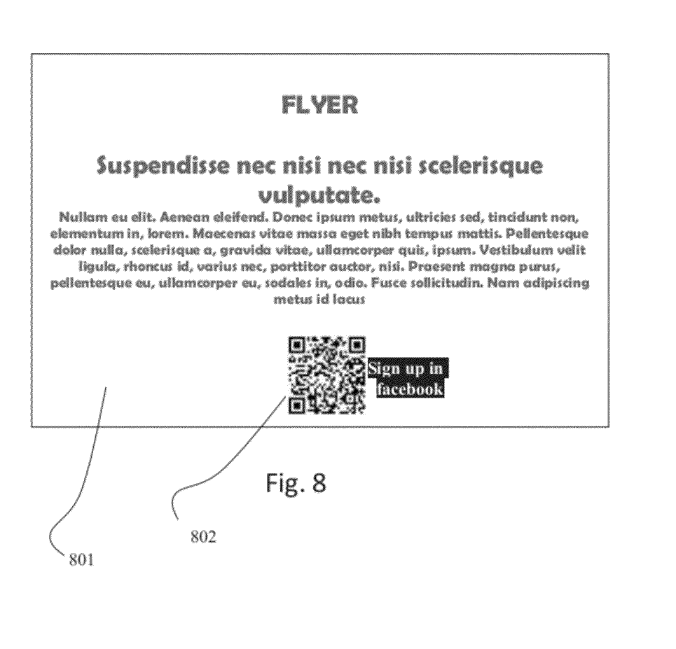

In FIG. 8 a further example is shown wherein an event advertisement (e.g. shown on television, printed in a magazine, or the like) is provided with a matrix code 802. By means of scanning the matrix code on a suitable smartphone, a user can sign up for the event.

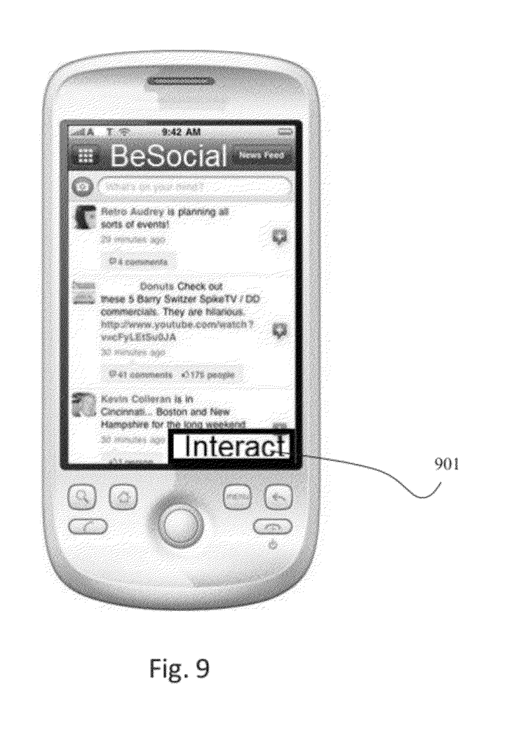

FIG. 9 depicts a screen from a smartphone that allows for user interaction with the external world, and especially with barcodes in the external world, by means of a button 901 and software running on the smartphone or networked servers in communication therewith adapted for this purpose.

As should be clear from the examples, the user in essence is able to interact with network servers (such as those running facebook, twitter or the like) by means of the matrix codes and appropriate software.

All examples discussed herein are non-limiting examples.

The disclosed embodiments may be variously combined.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

What is claimed is:

1. A method for user interaction with network servers by means of matrix codes comprising steps:
a. generating a matrix code associated with an object;
b. scanning said matrix code by means of software adapted for such purpose;
c. interacting with digital objects associated with said matrix code by means of software adapted for such purpose;
whereby said user may interact with said networked servers by means of said matrix codes.

2. The method of claim 1 wherein said network servers are associated with a social network.

3. The method of claim 1 wherein said matrix barcode is generated by an entity selected from the group consisting of: a social network, a web application, a third party.

4. The method of claim 1 wherein said external object is selected from the group consisting of: a person, a place, an event, an article, a billboard, an advertisement, an invitation.

5. The method of claim 1 wherein said matrix code is selected from the group consisting of: a two-dimensional bar code, a one-dimensional bar code, a three-dimensional bar code, a holographic bar code, an audio bar code, a video bar code.

6. The method of claim 1 wherein said software runs on a portable device capable of connecting to the internet and scanning matrix codes.

7. The method of claim 1 wherein said interaction takes a form selected from the group consisting of: pressing a button, entering information, speaking, writing, and gesturing or interacting with a touchscreen by drawing, dragging, pressing, tapping, with one or more fingers or stylus.

8. The method of claim 5 wherein said button is selected from the group consisting of: a ‘like’ button, an attendance button, a maybe button, a write to wall button, a add friend button, a non-attendance button, a comment button, a message button, a ‘poke’ button, buttons depending upon the identity of said user, buttons depending upon the identity of said object, and buttons depending upon the relation between said user and said object.

9. The method of claim 1 wherein said matrix code is used to identify an entity selected from the group consisting of: person, place, thing, business, institution, organization, group, event, product.

10. The method of claim 1 wherein said matrix code is used to interact with an entity selected from the group consisting of: person, place, thing, business, institution, organization, group, event, product.

11. A system for user interaction with network servers by means of matrix codes comprising:
a. a matrix code associated with an external object;
b. means for scanning said matrix code;
c. means for interacting with digital objects associated with said matrix code;
wherein said user may interact with said networked servers by means of said matrix codes.

12. The system of claim 11 wherein said network servers are associated with a social network.

13. The system of claim 11 wherein said external object is selected from the group consisting of: a person, a place, an event, an article, a billboard, an advertisement, an invitation.

14. The system of claim 11 wherein said matrix code is selected from the group consisting of: a two-dimensional bar code, a one-dimensional bar code, a three-dimensional bar code, a holographic bar code, an audio bar code, a video bar code.

15. The system of claim 11 wherein said software runs on a cell phone or any other portable or handheld device capable of connecting to the internet and scanning matrix barcodes.

16. The system of claim 11 wherein said interaction takes a form selected from the group consisting of: pressing a button, entering information, speaking, writing, gesturing, interacting with a touchscreen by means of pressing, drawing, dragging, and tapping.

17. The system of claim 15 wherein said button is selected from the group consisting of: a ‘like’ button, an attendance button, a non-attendance button, a comment button, a message button, a ‘poke’ button, buttons depending upon the identity of said user, buttons depending upon the identity of said object, and buttons depending upon the relation between said user and said object.

18. The system of claim 11 wherein said matrix code is used to identify an entity selected from the group consisting of: person, place, thing, business, institution, organization, group, event, product.

19. The system of claim 11 wherein said matrix code is used to interact with an entity selected from the group consisting of: person, place, thing, business, institution, organization, group, event, product.

20. A method for performing an action using a matrix barcode associated with a social network, comprising steps of reading said matrix barcode by means of a smartphone application, verifying that said matrix barcode has been generated by said social network, decoding data embedded in said matrix barcode, and retrieving from said social network a relevant digital object.
